(19) United States
(12) Patent Application Publication
(10) Pub. No.: US 2026/0031712 A1
(43) Pub. Date: Jan. 29, 2026

(54) SWITCHING POWER CONVERTERS, AND METHODS AND CONTROL MODULES FOR OPERATING SAME

(71) Applicant: SEMICONDUCTOR COMPONENTS INDUSTRIES, LLC, Scottsdale, AZ (US)

(72) Inventors: Roman STULER, Karolinka (CZ); Vaclav DRDA, Valasska Bystrice (CZ)

(73) Assignee: SEMICONDUCTOR COMPONENTS INDUSTRIES, LLC, Scottsdale, AZ (US)

(21) Appl. No.: 18/784,012

(22) Filed: Jul. 25, 2024

(51) Int. Cl. H02M 1/12; H02M 1/00; H02M 1/42; H02M 1/44

(52) U.S. Cl. CPC H02M 1/12; H02M 1/0009; H02M 1/4208; H02M 1/44

(57) ABSTRACT

Switching power converters, and methods and control modules for operating same. At least one example is a method of operating a switching power converter, the method comprising: generating, by a regulator, a drive signal that is periodic, each period defining an on-time and an off-time; passing unchanged, by a transition controller, the drive signal to an electrically-controlled switch; and then responsive to a mode controller changing conduction modes of an inductor of the switching power converter, conveying with adjustments, by the transition controller, the drive signal to the electrically-controlled switch.

### CROSS-REFERENCE TO RELATED APPLICATIONS

Not Applicable.

### BACKGROUND

Switching power converters, such as power factor correction (PFC) switching power converters, implement varying conduction modes of a main inductor. The conduction modes may include continuous-conduction mode (CCM), critical-conduction mode (CrCM), and discontinuous-conduction mode (DCM). Within the DCM, valley switching may occur in any selected voltage valley of the parasitic voltage oscillations of a switch node. Each time the conduction mode is changed, current drawn from the AC mains changes abruptly, which increases total harmonic distortion.

### SUMMARY

On example is a method of operating a switching power converter, the method comprising: generating, by a regulator, a drive signal that is periodic, each period defining an on-time and an off-time; passing unchanged, by a transition controller, the drive signal to an electrically-controlled switch; and then responsive to a mode controller changing conduction modes of an inductor of the switching power converter, conveying with adjustments, by the transition controller, the drive signal to the electrically-controlled switch.

In the example method, the conveying with adjustment may comprise modifying the on-time during a plurality of periods of the drive signal.

In the example method, conveying with adjustments may comprise, when an absolute value of an AC power signal applied to the switching power converter is rising, decreasing the on-time for at least one period.

In the example method, conveying with adjustments may comprise, when an absolute value of an AC power signal applied to the switching power converter is rising, decreasing the on-time for at least one period and then increasing the on-time for at least one period.

In the example method, conveying with adjustments may comprise, when an absolute value of an AC power signal applied to the switching power converter is falling, increasing the on-time for at least one period.

In the example method, conveying with adjustments may comprise, when an absolute value of an AC power signal applied to the switching power converter is falling, increasing the on-time for at least one period and then decreasing the on-time for at least one period.

In the example method, conveying with adjustments may comprise modifying the on-time based on a previous on-time in a previous period. The previous on-time in the previous period may be an immediately previous on-time in an immediately previous period.

In the example method, changing between conduction modes may comprise changing between at least one selected from a group comprising: discontinuous-conduction mode (DCM) and critical-conduction mode (CrCM); and CrCM and continuous-conduction mode (CCM).

In the example method, changing between conduction modes may comprise changing between at least one selected from a group comprising: third-valley discontinuous-conduction mode (DCM) and second-valley DCM; second-valley DCM and first-valley DCM.

In the example method, the switching power converter may be a power-factor correcting switching power converter.

Another example is a control module for a switching power converter, comprising: an input-sense terminal, a switch-node terminal, a drive terminal, and a controller. The controller may comprise: a regulator configured to generate a drive signal that is periodic, each period defining an on-time and an off-time; a mode controller coupled to the input-sense terminal and the regulator, the mode controller configured to change conduction modes implemented by the regulator based on a state of a sense signal received from the input-sense terminal; and a transition controller coupled to the regulator, the mode controller, and the drive terminal. The transition controller may be configured to: pass unchanged the drive signal to the drive terminal during at least some periods of the drive signal; and responsive to the mode controller changing conduction modes, convey with adjustments the drive signal to the drive terminal.

In the example control module, when the transition controller conveys with adjustment, the transition controller may be configured to modify the on-time during a plurality of periods of the drive signal.

In the example control module, when the transition controller conveys with adjustments, the transition controller may be configured to: sense an input-sense signal from the input sense terminal; and while the input-sense signal is rising, decrease the on-time for at least one period.

In the example control module, when the transition controller conveys with adjustments, the transition controller may be configured to: sense an input-sense signal from the input sense terminal; and while the input-sense signal is rising, decrease the on-time for at least one period and then increase the on-time for at least one period.

In the example control module, when the transition controller conveys with adjustments, the transition controller may be configured to: sense an input-sense signal from the input sense terminal; and while the input-sense signal is falling, increase the on-time for at least one period.

In the example control module, when the transition controller conveys with adjustments, the transition controller may be configured to: sense an input-sense signal from the input sense terminal; and while the input-sense signal is falling, increase the on-time for at least one period and then decrease the on-time for at least one period.

In the example control module, when the mode controller changes conduction modes, the mode controller may be configured to change between at least one selected from a group comprising: discontinuous-conduction mode (DCM) and critical-conduction mode (CrCM); and CrCM and continuous-conduction mode (CCM).

In the example control module, when the mode controller changes conduction modes, the mode controller may be configured to change between at least one selected from a group comprising: third-valley discontinuous-conduction mode (DCM) and second-valley DCM; second-valley DCM and first-valley DCM.

Another example is a switching power converter comprising: a rectifier defining a rectified output and a return; an inductor having a first lead coupled to the rectified output, and a second lead defining a switch node; a diode having an anode coupled to the switch node, and a cathode defining a positive polarity connection; an electrically-controlled switch having a first lead coupled to the switch node, a second lead coupled the return, and a control input; and a control module coupled to the control input and the positive polarity connection. The control module may comprise: a regulator configured to generate a drive signal that is periodic, each period defining an on-time and an off-time; a mode controller coupled to the regulator, the mode controller configured to change conduction modes implemented by the regulator; and a transition controller coupled to the regulator, the mode controller, and the control input. The transition controller may be configured to: pass unchanged the drive signal to the control input during at least some periods of the drive signal; and responsive to the mode controller changing conduction modes, convey with adjustments the drive signal to the control input.

### BRIEF DESCRIPTION OF THE DRAWINGS

For a detailed description of example embodiments, reference will now be made to the accompanying drawings in which:

FIG. 1 shows a partial electrical schematic, partial block diagram, of an example switching power converter;

FIG. 2 shows a plurality of waveforms as a function of corresponding time;

FIG. 3 shows a series of co-plotted waveforms, and a drive signal, as a function of corresponding time;

FIG. 4 shows a series of co-plotted waveforms, and a drive signal, as a function of corresponding time;

FIG. 5 shows a plurality of waveforms as a function of corresponding time; and

FIG. 6 shows an example method.

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or a direct connection. Thus, if a first device is coupled to a second device, that connection may be through a direct connection or through an indirect connection via other devices and connections.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions. To be clear, an initial reference to “a [referent]”, and then a later reference for antecedent basis purposes to “the [referent]”, shall not obviate the fact the recited referent may be plural.

In relation to electrical devices (whether stand alone or as part of an integrated circuit), the terms “input” and “output” refer to electrical connections to the electrical devices, and shall not be read as verbs requiring action. For example, a differential amplifier (such as an operational amplifier) may have a first differential input and a second differential input. These “inputs” define electrical connections to the operational amplifier, and shall not be read to require inputting signals to the operational amplifier.

“Assert” shall mean creating or maintaining a first predetermined state of a Boolean signal. Boolean signals may be asserted high or with a higher voltage, and Boolean signals may be asserted low or with a lower voltage, at the discretion of the circuit designer. Similarly, “de-assert” shall mean creating or maintaining a second predetermined state of the Boolean, opposite the asserted state.

“Passing unchanged” or “pass[ ] unchanged” shall mean that a signal applied to an input is passed to an output without modifying the duration of an on-time of the signal passed to the output. Propagation delay, polarity change, and/or amplitude change shall not obviate that a signal is passed unchanged.

“Conveying with adjustments” or “convey[ ] with adjustments” shall mean that a signal applied to an input is transferred to an output, and as part of the transfer an on-time of the signal is modified (e.g., lengthen or shortened).

“Periodic” shall mean that signal has a repeating pattern, and the duration between corresponding features defines a period; however, a signal being periodic shall not be read to require that the period, or frequency, of the signal is the same from period-to-period.

“Controller” shall mean, alone or in combination, individual circuit components, an application specific integrated circuit (ASIC), a microcontroller with controlling software, a reduced-instruction-set computer (RISC) with controlling software, a digital signal processor (DSP), a processor with controlling software, a programmable logic device (PLD), a field programmable gate array (FPGA), or a programmable system-on-a-chip (PSOC), configured to read inputs and drive outputs responsive to the inputs.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various examples are directed to a switching power converter designed and constructed to reduce total harmonic distortion (THD) created by changes in conduction mode implemented by a control module of the switching power converter. More particularly, various examples are directed to a control module for switching power converters, such as power factor correction (PFC) switching power converters, where the control module makes adjustments to the duration of the charge modes of the switching power converter, the adjustments responsive to changes in the conduction mode implemented. More particularly still, the control module adjusts durations of charge modes for a plurality of charge modes to keep the average current through the main inductor about same after a change in conduction mode, thus reducing total harmonic distortion. The specification now turns to an example system to orient the reader.

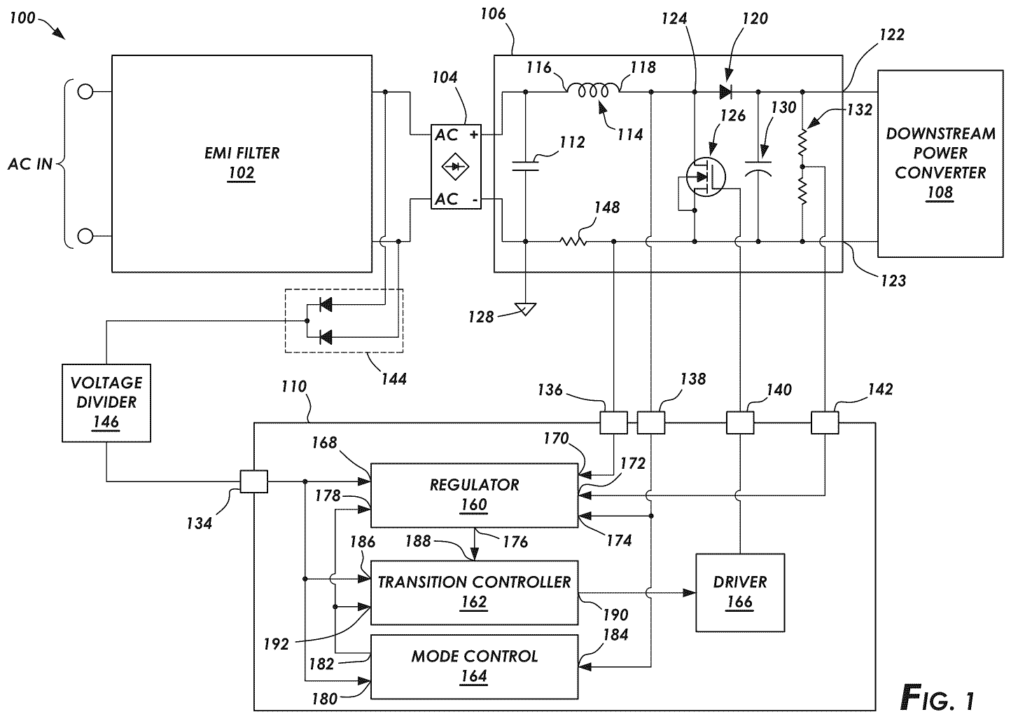

FIG. 1 shows an example switching power converter 100. In particular, the example switching power converter 100 comprises an electromagnetic interference (EMI) filter 102, a rectifier 104, a switching circuit 106, a load in the example form of a downstream power converter 108, and a control module 110. The EMI filter 102 defines input terminals coupled to an AC power signal (e.g., 120V AC, 240V AC, 50 Hz or 60 Hz). The EMI filter 102 includes inductors, capacitors, and choke transformers, all selected and arranged to reduce noise from propagating out of and into the switching power converter 100. The precise arrangement of the EMI filter depends on a variety of factors, such as the particular use of the switching power converter 100, and the total harmonic distortion thresholds sets by various governing bodies for the particular use.

The EMI filter 102 is coupled to the rectifier 104, and the rectifier 104 is coupled to the switching circuit 106. The rectifier converts the AC power signal applied to the rectifier 104 to a DC power signal. In one example, the rectifier 104 is a full-wave rectifier. However, in other cases, such as switching power converters for low power uses, the rectifier may implement half-wave rectification. The rectifier 104 provides the DC power signal to the switching circuit 106.

Still referring to FIG. 1, the example switching circuit 106 includes a capacitor 112 having a first lead coupled to the positive polarity input of the switching circuit 106 and a second lead coupled to the negative polarity input of the switching circuit 106. The capacitor 112 reduces the switching converter ripple current from reaching the AC mains. While only a single smoothing capacitor 112 is shown so as not to unduly complicate the figure, additional filtering elements may be present, such as additional capacitors and inductors.

The example switching circuit 106 further includes an inductor 114 having a first lead 116 coupled to the positive polarity input, and a second lead 118 coupled the anode of a diode 120. The cathode of the diode 120 defines a voltage output 122 of the switching circuit 106. The electrical node between the second lead 118 and the anode of the diode 120 defines a switch node 124. In order to sense inductor current during charge modes, the example switch circuit 106 includes a current-sense resistor 148 coupled between the return connection 123 and the return connection of the rectifier 104. The return connection of the rectifier 104 may be referred to as the common or return 128.

The example switch circuit 106 further includes an electrically-controlled switch coupled between the switch node 124 and the return connection 123 of the switching circuit 106. In example cases, and as shown, the electrically-controlled switch may be implemented as field-effect transistor (FET), and is hereafter referred to as FET 126. The example FET 126 defines a drain coupled the switch node 124, a source coupled to the return 128 by way of the current-sense resistor 148, and a gate. When the gate of the FET 126 is asserted, the FET 126 is conductive, which couples the switch node 124 to the return 128. During periods of time when the switch node 124 is coupled to the return 128, current through the inductor 114 increases. Coupling the switch node 124 to the return 128 is referred to as the charge mode, because as the current increases, the inductor 114 stores energy in the magnetic field around the inductor 114. Also during charge modes, the anode of the diode 120 has a lower voltage than the cathode, and thus the diode 120 blocks reverse current flow.

When the gate of the FET 126 is de-asserted, the FET 126 becomes non-conductive, thus de-coupling the switch node 124 from the return 128. Because current through the inductor 114 cannot change instantaneously, when the FET is non-conductive, the magnetic field around the inductor 114 collapses, raising the voltage at the switch node 124 and forward biasing the diode 120. Thus, current is provided from the inductor 114 to the downstream components. Periods of time when the FET 126 is non-conductive may be referred as discharge modes.

Still referring to FIG. 1, the example switch circuit 106 includes a capacitor 130 defining a first lead coupled the cathode of the diode 120 and a second lead coupled the return 123. The capacitor 130 may smooth the voltage applied the downstream load, store energy during discharge modes, and supply energy to the downstream load during charge modes when the diode 120 is reverse biased.

The control module 110 may sense the output voltage of the switching circuit 106 as part of a closed-loop control scheme. In some cases, the control module 110 may couple directly to the voltage output 122 of the switching circuit 106; however, in other cases, and as shown, sensing the output voltage may be by way of a voltage divider 132. In particular, the example switching circuit 106 may include a voltage divider 132 comprising two resistors in series coupled between the voltage output 122 output and the return 123. An electrical node between the resistors defines a sense node having scaled version of the output voltage that is provided to the control module 110.

The switching circuit 106 is coupled to and controlled by the control module 110. The example control module 110 defines a plurality of externally accessible electrical terminals, such as an input-sense terminal 134, a current-sense terminal 136, a switch-node terminal 138, a drive terminal 140, and a feedback terminal 142. Additional terminals may be present, such as a power terminal and a ground terminal, but such additional terminals are not shown so as not to unduly complicate the figure.

The example input-sense terminal 134 is coupled to the AC power signal downstream of the EMI filter 102, the example coupling by way of a rectifier 144 and a voltage divider 146. Thus, the control module 110 receives a sense signal at the input-sense terminal 134 that is indicative of the instantaneous voltage of the AC power signal applied to the EMI filter 102. The current-sense terminal 136 is coupled to the current-sense resistor 148. In some examples, ending each charge mode is based on the current through the inductor 114 reaching a peak current setpoint. Current-sense resistor 148 is a small value resistor in the return path that produces a voltage proportional to current. Thus, the control module 110 senses inductor current in each charge mode by way of the current-sense terminal 136. Other current sensing techniques may be equivalently used.

The switch-node terminal 138 is coupled to the switch node 124 for sensing purposes, such as sensing voltage oscillation of the switch node 124. The drive terminal 140 is coupled to the gate of the FET 126 to control the conductive state of the FET 126, and thus to control the charge and discharge modes of the inductor 114. The feedback terminal 142 is coupled the node between the resistors of the voltage divider 132, such as to sense the output voltage for control purposes.

Still referring to FIG. 1, the example control module 110 includes a regulator 160, a transition controller 162, a mode controller 164, and a driver 166. Additional components and functionality may be present, such as over-voltage protection circuits, under-voltage protection circuits, soft-start circuits, and low-power cycle skip circuits, but such additional circuits are not shown so as not to unduly complicate the figure and the discussion. The example regulator 160 defines a supply-sense input 168 coupled to the input-sense terminal 134, a current-sense input 170 coupled to the current-sense terminal 136, a feedback input 172 coupled to the feedback terminal 142, a node-sense input 174 coupled to the switch-node terminal 138, a drive output 176 coupled to the transition controller 162, and a mode input 178 coupled to the mode controller 164.

The regulator 160 senses the magnitude of the AC power signal by way of the supply-sense input 168. The regulator 160 senses the inductor current during each charge mode by way of the current-sense input 170. The regulator 160 senses the output voltage of the switching circuit 106 by way of the feedback input 172. The regulator 160 senses the voltage on the switch node 124 by way of the node-sense input 174. Using some or all the sensed parameters, the regulator 160 creates a drive signal provided to the drive output 176. The drive signal is a periodic signal, with each period defining an asserted or on-time and a de-asserted or off-time. Each on-time of the drive signal defines a charge mode, and each off-time of the drive signal defines a discharge mode. Thus, the regulator 160 is designed and constructed to modify the on-times and the off-times to control or regulate the output voltage.

The drive signal created by the regulator 160 implements a conduction mode designated by one or more signals received from the mode controller 164 through the mode input 178. For example, the regulator may implement a continuous-conduction mode (CCM), a critical-conduction mode (CrCM), or a discontinuous-conduction mode (DCM). In continuous-conduction mode, the current through the inductor 114 does not reach zero in each discharge mode before the next charge mode begins. In critical-conduction mode, the current through the inductor 114 reaches or substantially reaches zero in the discharge mode before the next charge mode begins. Stated otherwise, in the critical-conduction mode the next charge mode begins contemporaneously with the inductor 114 current reaching zero. In discontinuous-conduction mode, the current through the inductor 114 is allowed to reach zero, and the voltage at the switch node 124 is allowed to oscillate. In some examples, the next charge mode begins in a voltage valley of the voltage oscillation of the switch node 124, such as one of the first through fifth valleys.

The mode controller 164 defines a supply-sense input 180 coupled to the input-sense terminal 134, a mode output 182 coupled to the regulator 160, and a node-sense input 184 coupled to the switch-node terminal 138. The mode controller 164 is designed and constructed to select a conduction mode for the inductor 114 based on the sensed parameters, and provide a mode-selection signal to the regulator 160. In the example of FIG. 1, the switching power converter 100 is a power factor correction switching power converter, and thus the load is the downstream power converter 108. In operation as a power factor correction switching power converter, the mode changes are primarily driven by the instantaneous voltage of the AC power signal. That is, the goal of the switching power converter 100 operated for power factor correction is to draw power from the AC mains with a power factor close to unity. Thus, the example mode controller 164 senses the instantaneous voltage of the AC power signal, and sets the conduction mode accordingly. The developmental context of the current specification is power factor correction switching power converters, and the description that follows is based on the developmental context; however, the various techniques to reduce total harmonic distortion are applicable with any switching power converter, and thus the developmental context shall not be read as a limitation.

The transition controller 162 defines a supply-sense input 186 coupled to the input-sense terminal 134, a drive input 188 coupled to the drive output 176, a drive output 190 coupled to the driver 166, and a mode input 192 coupled to the mode controller 164. The driver 166 is coupled to the drive terminal 140. The driver 166 is designed and constructed to supply current and voltage the gate of the FET 126 to control the conductive state of the FET 126 responsive to the asserted or de-asserted state of the drive signal passed from the transition controller 162. The example transition controller 162 is designed and constructed to make adjustments to the duration of one more charge modes responsive to changes in the conduction mode. More particularly, responsive the mode controller 164 changing conduction modes, the transition controller 162 conveys the drive signal with adjustments to the driver 166 and thus to the gate of the FET 126. The adjustments modify the on-time of the drive signal in at least one period following a change in conduction mode. After the adjustments, the transition controller 162 passes the drive signal unchanged to the driver 166, until the next change in conduction mode. Before discussing the adjustments in greater detail, the specification turns to a description of the effects of conduction mode changes.

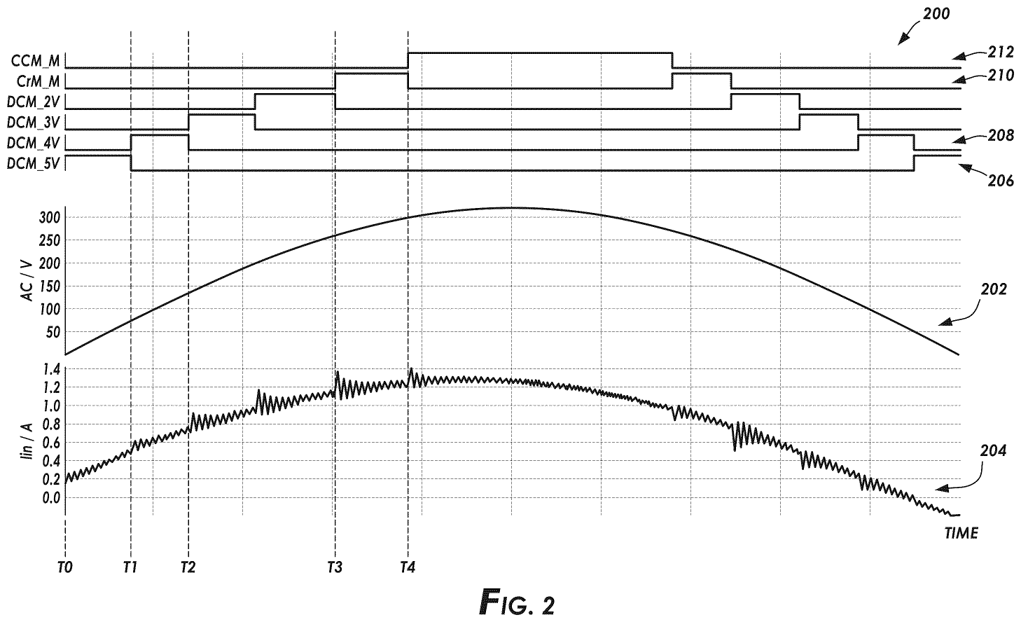

FIG. 2 shows a plurality of waveforms as a function corresponding of time. In particular, the upper plot 200 shows a plurality of Boolean signals indicating conduction mode as a function of time, the middle plot 202 shows a representation of the instantaneous voltage of the AC power signal during a portion of the positive half-cycle, and the lower plot 204 shows current drawn from the AC mains. Again, power factor correction switching power converters are designed and constructed to draw power from the AC mains having a power factor close to unity. Having power factor close to unity means that the instantaneous current drawn from the AC mains closely matches the instantaneous voltage amplitude of the AC power signal—rising and falling in unison. In order to have the current draw ramp up and down with the instantaneous voltage, the switching power converter transitions through the various conduction modes.

For example, between time T0 and time T1, an example switching power converter may be operated in the discontinuous-conduction mode, fifth valley, as shown by the signal 206 (DCM_5V). At time T1, the switching power converter may switch to discontinuous-conduction mode, fourth valley, as shown by the signal 208 (DCM_4V). As the instantaneous voltage continues to rise, the switching power converter makes conduction mode changes to discontinuous-conduction mode, third valley at time T2, and so on. At time T3, the switching power converter changes to critical-conduction mode as shown by the signal 210 (CrM_M), and then at time T4 the switching power converter changes to continuous-conduction mode as shown by the signal 212 (CCM_M). As the instantaneous voltage falls, the switching power converter steps the opposite way through the various conduction modes.

The lower plot 204 shows current drawn from the AC mains over time. Each time the switching power converter makes a valley change in discontinuous-conduction mode, the mode change results in a parasitic oscillation in the current drawn, as shown the waveforms following time T1 and following time T2. Each time the switching power converter switches from discontinuous-conduction mode to critical-conduction mode, the mode change results in a parasitic oscillation in the current drawn, as shown the waveform following time T3. Each time the switching power converter switches from critical-conduction mode to the continuous-conduction mode, the mode change results in a parasitic oscillation in the current drawn, as shown the waveform following time T4. Though not specifically delineated, the mode changes as the instantaneous voltage of the AC power signal falls also causes parasitic oscillation in the current drawn. Each of the parasitic oscillations caused by mode changes increases the total harmonic distortion generated in AC mains by the switching power converter.

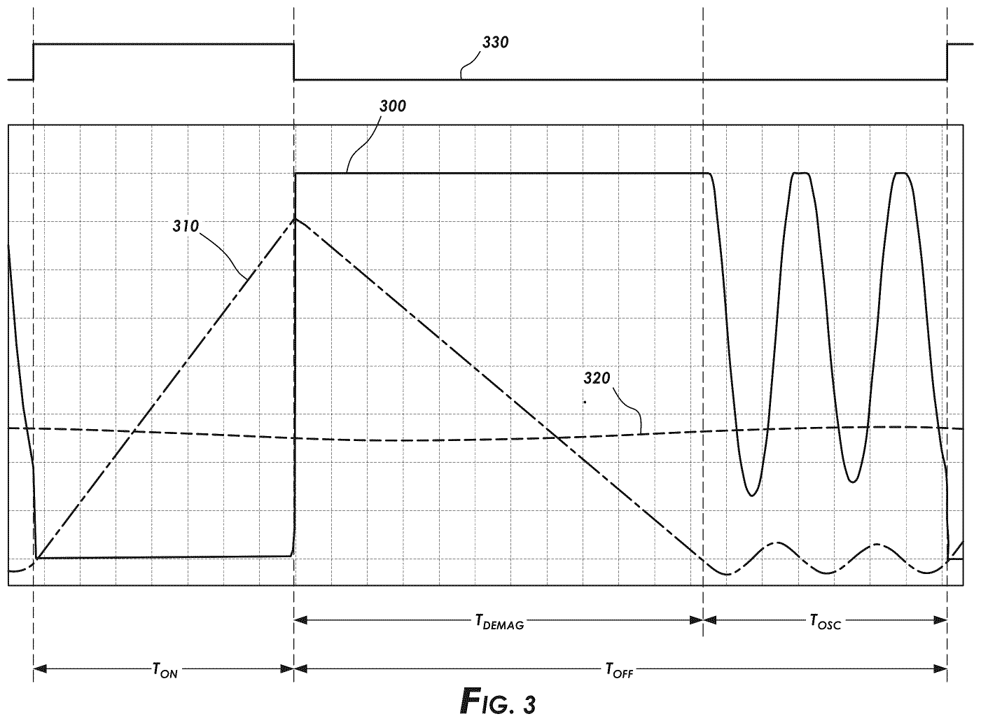

FIG. 3 shows a series of co-plotted waveforms, as well as an example drive signal. In particular, FIG. 3 shows a switch-node voltage 300 showing the voltage at the switch node 124, an inductor current 310 showing current through the inductor 114, an average inductor current 320 showing average of the inductor 114 current over time, and an example drive signal 330. In particular, the drive signal 330 is a Boolean signal that, in this example, is asserted high or with a higher voltage. The drive signal 330 defines an on-time T_{ON}, and an off-time T_{OFF}. The combination of the on-time T_{ON} and the off-time T_{OFF} define the period of the drive signal 330.

During the on-time T_{ON}, the FET 126 is conductive and thus the voltage at the switch node 124 is effectively the same as the return 128. During the example on-time T_{ON}, the inductor current 310 is rising from zero. At the end of the on-time T_{ON}, the FET 126 is made non-conductive, thus beginning the off-time T_{OFF}. The duration between the peak current through the inductor 114 at the end of the on-time T_{ON} and the inductor current reaching zero is referred to as the demagnetization time T_{DEMAG}. During the demagnetization time T_{DEMAG}, the switch-node voltage 300 rises to the DC output voltage of the switch circuit 106 (FIG. 1). At the end of the demagnetization time T_{DEMAG}, the switch-node voltage 300 begins to oscillate, as the inductor 114 interacts with various capacitances of the switch circuit 106. Stated otherwise, oscillations in the inductor 114 current result in voltage oscillations of the switch-node voltage 300. During discontinuous-conduction mode, the switch-node voltage 300 oscillations through one or more voltage valleys, with the next on-time T_{ON} triggered within a voltage valley. In the example of FIG. 3, the next on-time begins in the third voltage valley of the switch-node voltage 300, but any voltage valley may be selected. The duration between the end of the demagnetization time T_{DEMAG} and the beginning of the next on-time T_{ON} is shown in the figure as the oscillation time T_{OSC}. As shown then, the off-time T_{OFF} is the combined duration of the demagnetization time T_{DEMAG} and oscillation time T_{OSC}.

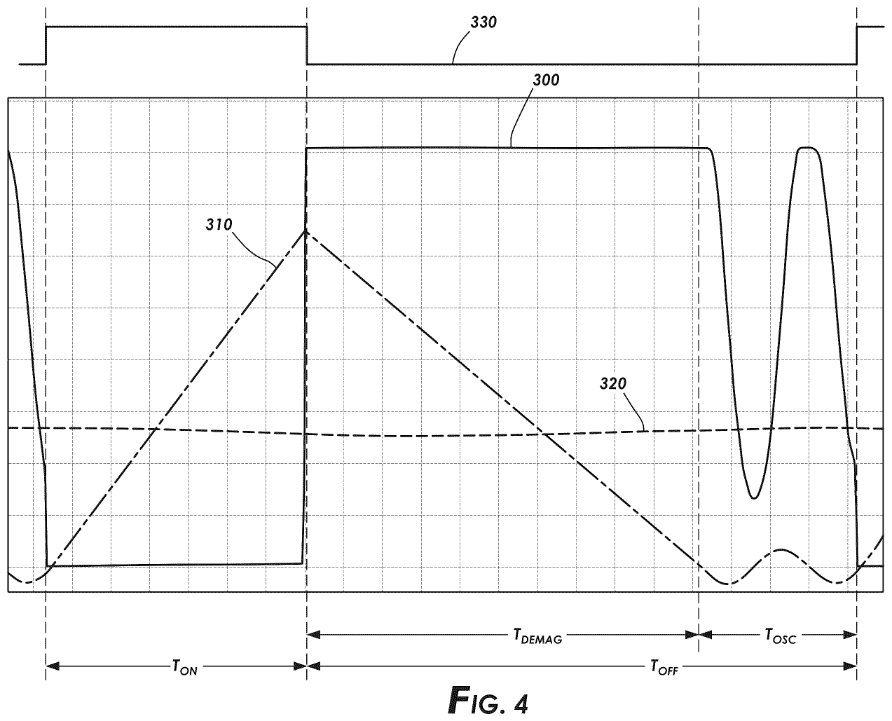

FIG. 4 shows a series of co-plotted waveforms, as well as an example drive signal. In particular, FIG. 4 also includes a switch-node voltage 300, the inductor current 310, the average inductor current 320, and an example drive signal 330. In FIG. 4 shows an on-time T_{ON}, an off-time T_{OFF}, and an oscillation time T_{OSC}, all corresponding to the example drive signal 330. In the example of FIG. 4, however, the off-time T_{OFF} ends in the second voltage valley of the switch-node voltage 300, and thus the oscillation time T_{OSC} is shorter than that of FIG. 3.

Assume, for purposes of explanation, that FIGS. 3 and 4 represent a change of conduction mode for a switching power converter attempting to maintain a constant average inductor current, with all other parameters (e.g., DC output voltage, instantaneous voltage of the AC power signal) held constant. To keep the average inductor current constant, the change from switching in the third valley (FIG. 3) to switching in the second valley (FIG. 4) may require change in the subsequent on-time. Equation (1) below shows a relationship between the on-times:

$$\frac{Ton 3}{Ton 2} = \frac{1 + k \frac{Tosc 3}{Tosc 3}}{1 + k \frac{Tosc 2}{Tosc 2}} \qquad ( 1 )$$

where Ton3 is the on-time for third-valley switching, Tosc3 is the oscillation time in third-valley switching, Ton2 is the on-time for second-valley switching, Tosc2 is the oscillation time for second valley switching, and where k is a constant. For one particular example, to maintain the average inductor current, changing from third-valley switching to second-valley switching may mean a change of on-time of 3.614 microseconds to 3.346 microsecond, respectively. However, in order to maintain loop stability, the regulator 160 cannot change on-time that quickly.

Stated differently, the regulator 160 may be composed of an on-time controller and an off-time controller. The on-time controller may control on-time by controlling a peak current setpoint for each charge mode, with the peak current setpoint based on a voltage error between the setpoint voltage and the voltage sensed by way of the feedback terminal 142. The off-time controller implements the conduction mode set by the mode controller 164. When the mode controller 164 changes the conduction mode, the off-time changes, but the on-time controller does not sense the off-time change directly; rather, the on-time controller is responsive to changes in the voltage error, which, with on-time held constant, may take many charge and discharge modes to manifest in a change of the output voltage. Thus, the on-time controller continues to set the on-time without the knowledge that the on-time adjustments may be needed to maintain constant average current.

In various examples, the transition controller 162 makes adjustments to on-time responsive to changes in the conduction mode. More particularly still, after a change in conduction mode, the transition controller 162 adjusts the duration of at least one on-time (i.e., at least one charge mode) to keep the average current through the inductor 114 about the same. That is, responsive to the mode controller 164 changing conduction modes, the transition controller 162 conveys the drive signal with on-time adjustments to the driver 166 and FET 126. After the corrections implemented by transition controller 162 have ended, and during periods of constant conduction mode, the transition controller 162 passes the drive signal unchanged to the driver 166 and FET 126. The specification now turns to a discussion of the adjustments to on-time in greater detail.

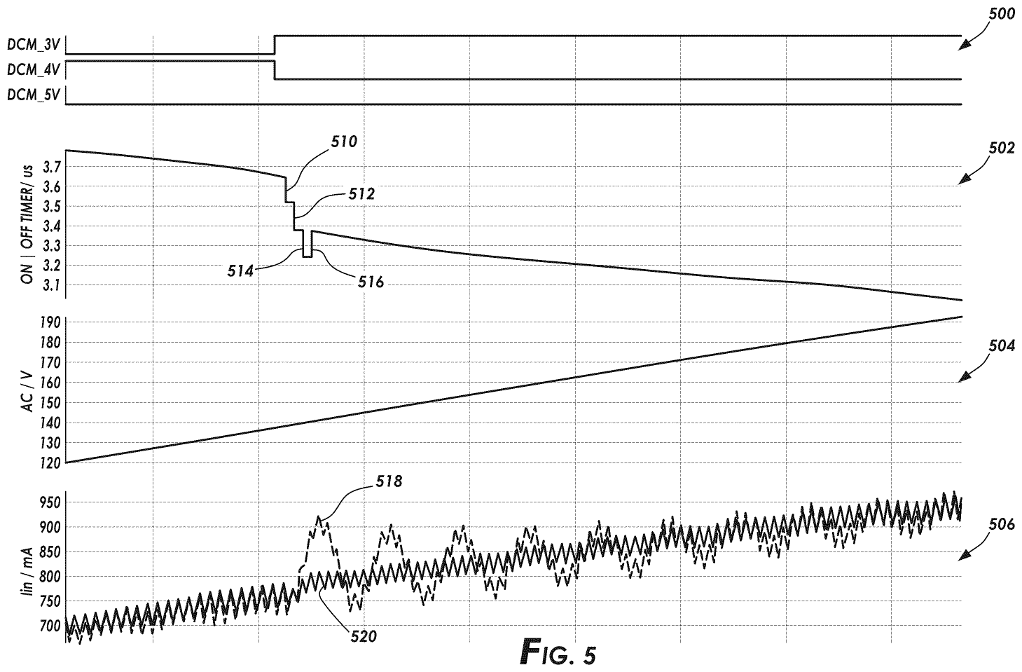

FIG. 5 shows a plurality of waveforms as a function of corresponding time. In particular, the upper plot 500 show a plurality of Boolean signals indicating conduction mode as a function of time, the upper-middle plot 502 shows a representation of on-time as a continuous function, the lower-middle plot 504 shows the instantaneous voltage of the AC power signal during a portion of positive half-cycle with the voltage rising, and the lower plot 506 shows current drawn from the AC mains both with and without the corrections implemented by the example embodiments. The upper plot 500 shows that the example situation is a transition from discontinuous-conduction mode, fourth valley, to discontinuous-conduction mode, third valley.

The upper-middle plot 502 is a continuous function constructed for purposes of explanation. That is, the example control module 110 (FIG. 1) may not have or produce a signal as shown by the upper-middle plot 502. Rather, the plot shows, as a continuous function, a representation of on-time over many periods of a drive signal (not shown in FIG. 5). As the instantaneous voltage of the AC power signal increases in value, as shown by the lower-middle plot 504, the on-time used to draw the same average current decreases; however, the change of conduction mode from fourth-valley switching to third-valley switching may cause the draw of more current than needed to maintain about the same average current. Thus, contemporaneously with the change in conduction mode from fourth-valley switching to third-valley switching, the control module 110, and in particular the transition controller 162 (FIG. 1), modifies the on-time within a plurality of periods. In the example shown, the transition controller 162 modifies the on-time for four contiguous on-times of the drive signal. In the first three periods, the on-time is reduced by a predetermined amount, as shown by steps 510, 512, and 514. In the fourth period, the transition controller 162 increases the on-time, as shown by step 516. Thereafter, the transition controller 162 passes unchanged the drive signal to the driver 166 and the FET 126.

The lower-plot 506 shows an uncorrected current 518 and a corrected current 520. In particular, the uncorrected current 518 shows the excursion of current drawn from the AC mains in the absence of modifying the on-time by the transition controller 162 (FIG. 1). Notice how the uncorrected current 518 jumps higher, and then shows a damped oscillation toward final range of values. The corrected current 520, by contrast exhibits less excursion from an average value, and thus a control module 110 (FIG. 1) implementing the corrections described herein produces lower total harmonic distortion.

The example adjustments of the upper-middle plot 502 include adjustments to four on-times in contiguous periods of the drive signal. However, adjustments to on-time in greater or fewer periods may be implemented. In one example, an adjustment to a single on-time may be sufficient. In other examples, adjustments may be made to the on-times of five or more contiguous periods.

Further still, the example adjustments of the upper-middle plot 502 include three reductions followed by one increase. However, when a plurality of adjustments is made, different combinations may be implemented. For example, there may be equal numbers of on-time reduction(s) and on-time increase(s). In another case, fewer reductions may be made but with larger step sizes, followed by a greater number of increases with decreased comparative step sizes. The specification and claims contemplate all such variations.

Though implied in various locations of this specification, the “direction” of adjustment may be based on the state of the instantaneous voltage of the AC power signal (e.g., positive half-cycle, negative half-cycle), and may be further based on whether the instantaneous voltage of the AC power signal is increasing in absolute value (e.g., first half of the positive half-cycle, first half of the negative half-cycle) or decreasing in absolute value (e.g., second half of the positive half-cycle, second half of the negative half-cycle). During the first half of the positive half-cycle, and the first half of the negative half-cycle, the adjustments may include: reducing the on-time for at least one period; reducing the on-time for a plurality of periods; and reducing the on-time for one or more periods, and then increasing the on-time for one or more periods. During the second half of positive half-cycle, and the second half of the negative half-cycle, the adjustments may include: increasing the on-time for at least one period; increasing the on-time for a plurality of periods; and increasing the on-time for one or more periods, and then decreasing the on-time for one or more periods.

The amount of adjustment made to an on-time period may take many forms. In one example, the transition controller 162 may adjust (e.g., increase or decrease) a predetermined amount. In other cases, the transition controller may adjust (e.g., increase or decrease) based on a predetermined series of values selected based on the absolute value of the instantaneous voltage of the AC power signal. In yet still other cases, the adjustment in a particular on-time may be based on the on-time in an immediately previous period. In yet still other cases, a first adjustment responsive to a change in conduction mode may be based on the on-time in the immediately previous period (e.g., the period before the change in conduction mode), and then subsequent adjustments may take any form discussed above.

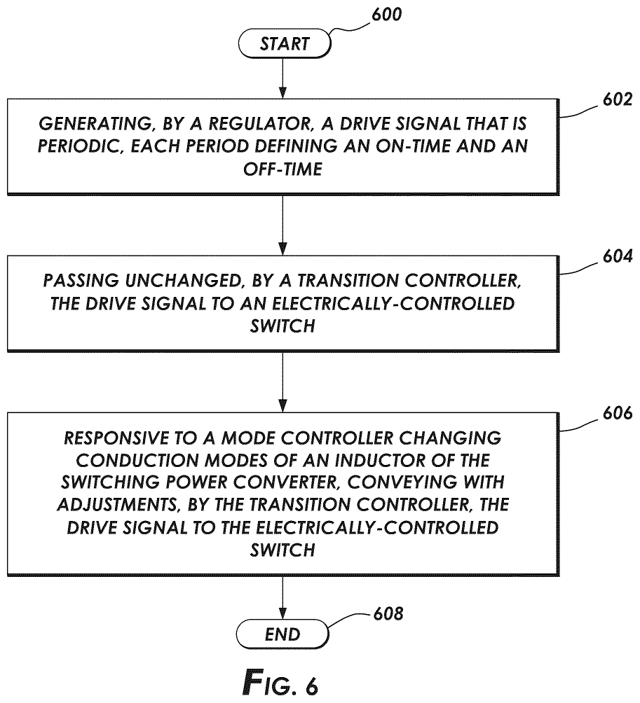

FIG. 6 shows a method in accordance with at least some embodiments. In particular, the method starts (block 600) and comprises: generating, by a regulator, a drive signal that is periodic, each period defining an on-time and an off-time (block 602); passing unchanged, by a transition controller, the drive signal to an electrically-controlled switch (block 604); and responsive to a mode controller changing conduction modes of an inductor of the switching power converter, conveying with adjustments, by the transition controller, the drive signal to the electrically-controlled switch (block 606). Thereafter, the method ends (block 608).

Many of the electrical connections in the drawings are shown as direct couplings having no intervening devices, but not expressly stated as such in the description above. Nevertheless, this paragraph shall serve as antecedent basis in the claims for referencing any electrical connection as “directly coupled” for electrical connections shown in the drawing with no intervening device(s).

The above discussion is meant to be illustrative of the principles and various embodiments of the present invention. Numerous variations and modifications will become apparent to those skilled in the art once the above disclosure is fully appreciated. For example, the transition controller may implement a constant bias or constant change of duration of each on-time. The constant bias or constant change of duration may be implemented either intentionally or parasitically; however, a constant bias or constant change in duration will be compensated by the regulator. Thus, a constant bias or constant change of duration shall not obviate that the transition controller passes unchanged an applied signal. It is intended that the following claims be interpreted to embrace all such variations and modifications.

What is claimed is:

1. A method of operating a switching power converter, the method comprising:
generating, by a regulator, a drive signal that is periodic, each period defining an on-time and an off-time;
passing unchanged, by a transition controller, the drive signal to an electrically-controlled switch; and then
responsive to a mode controller changing conduction modes of an inductor of the switching power converter, conveying with adjustments, by the transition controller, the drive signal to the electrically-controlled switch.

2. The method of claim 1 wherein the conveying with adjustment comprises modifying the on-time during a plurality of periods of the drive signal.

3. The method of claim 1 wherein the conveying with adjustments comprises, when an absolute value of an AC power signal applied to the switching power converter is rising, decreasing the on-time for at least one period.

4. The method of claim 1 wherein the conveying with adjustments comprises, when an absolute value of an AC power signal applied to the switching power converter is rising, decreasing the on-time for at least one period and then increasing the on-time for at least one period.

5. The method of claim 1 wherein the conveying with adjustments comprises, when an absolute value of an AC power signal applied to the switching power converter is falling, increasing the on-time for at least one period.

6. The method of claim 1 wherein the conveying with adjustments comprises, when an absolute value of an AC power signal applied to the switching power converter is falling, increasing the on-time for at least one period and then decreasing the on-time for at least one period.

7. The method of claim 1 wherein the conveying with adjustments comprises modifying the on-time based on a previous on-time in a previous period.

8. The method of claim 7 wherein the previous on-time in the previous period is an immediately previous on-time in an immediately previous period.

9. The method of claim 1 wherein changing between conduction modes comprises changing between at least one selected from a group comprising: discontinuous-conduction mode (DCM) and critical-conduction mode (CrCM); and CrCM and continuous-conduction mode (CCM).

10. The method of claim 1 wherein changing between conduction modes comprises changing between at least one selected from a group comprising: third-valley discontinuous-conduction mode (DCM) and second-valley DCM; second-valley DCM and first-valley DCM.

11. The method of claim 1 wherein the switching power converter is a power-factor correcting switching power converter.

12. A control module for a switching power converter, comprising:
an input-sense terminal, a switch-node terminal, and a drive terminal;
a controller comprising:
a regulator configured to generate a drive signal that is periodic, each period defining an on-time and an off-time;
a mode controller coupled to the input-sense terminal and the regulator, the mode controller configured to change conduction modes implemented by the regulator based on a state of a sense signal received from the input-sense terminal; and
a transition controller coupled to the regulator, the mode controller, and the drive terminal, the transition controller configured to:
pass unchanged the drive signal to the drive terminal during at least some periods of the drive signal; and
responsive to the mode controller changing conduction modes, convey with adjustments the drive signal to the drive terminal.

13. The control module of claim 12 wherein when the transition controller conveys with adjustment, the transition controller is configured to modify the on-time during a plurality of periods of the drive signal.

14. The control module of claim 12 wherein when the transition controller conveys with adjustments, the transition controller is configured to:
sense an input-sense signal from the input sense terminal; and
while the input-sense signal is rising, decrease the on-time for at least one period.

15. The control module of claim 12 wherein when the transition controller conveys with adjustments, the transition controller is configured to:
sense an input-sense signal from the input sense terminal; and
while the input-sense signal is rising, decrease the on-time for at least one period and then increase the on-time for at least one period.

16. The control module of claim 12 wherein when the transition controller conveys with adjustments, the transition controller is configured to:
sense an input-sense signal from the input sense terminal; and
while the input-sense signal is falling, increase the on-time for at least one period.

17. The control module of claim 12 wherein when the transition controller conveys with adjustments, the transition controller is configured to:
sense an input-sense signal from the input sense terminal; and
while the input-sense signal is falling, increase the on-time for at least one period and then decrease the on-time for at least one period.

18. The control module of claim 12 wherein when the mode controller changes conduction modes, the mode controller is configured to change between at least one selected from a group comprising: discontinuous-conduction mode (DCM) and critical-conduction mode (CrCM); and CrCM and continuous-conduction mode (CCM).

19. The control module of claim 12 wherein when the mode controller changes conduction modes, the mode controller is configured to change between at least one selected from a group comprising: third-valley discontinuous-conduction mode (DCM) and second-valley DCM; second-valley DCM and first-valley DCM.

20. A switching power converter comprising:
a rectifier defining a rectified output and a return;
an inductor having a first lead coupled to the rectified output, and a second lead defining a switch node;
a diode having an anode coupled to the switch node, and a cathode defining a positive polarity connection;
an electrically-controlled switch having a first lead coupled to the switch node, a second lead coupled the return, and a control input;
a control module coupled to the control input and the positive polarity connection, the control module comprising:
a regulator configured to generate a drive signal that is periodic, each period defining an on-time and an off-time;
a mode controller coupled to the regulator, the mode controller configured to change conduction modes implemented by the regulator; and
a transition controller coupled to the regulator, the mode controller, and the control input, the transition controller configured to:
pass unchanged the drive signal to the control input during at least some periods of the drive signal; and
responsive to the mode controller changing conduction modes, convey with adjustments the drive signal to the control input.
